(19) United States
(12) Patent Application Publication
(10) Pub. No.: US 2025/0385085 A1
(43) Pub. Date: Dec. 18, 2025

(54) ION ANALYZER

(71) Applicant: SHIMADZU CORPORATION, Kyoto (JP)

(72) Inventors: Ryosuke NARA, Kyoto (JP); Yuta MIYAZAKI, Kyoto (JP)

(21) Appl. No.: 19/217,857

(22) Filed: May 23, 2025

(30) Foreign Application Priority Data
Jun. 12, 2024 (JP) 2024-095183

(51) Int. Cl. H01J 49/02; G01N 30/72; H01J 49/16

(52) U.S. Cl. CPC H01J 49/022; G01N 30/7233; H01J 49/165

(57) ABSTRACT

Provided is an ion analyzer, including: a reaction chamber into which a precursor ion generated from an analyte is to be introduced; an electrode located within the reaction chamber; an active particle generator configured to generate an active particle from a predetermined kind of source gas; an active particle introducer configured to introduce an active particle generated by the active particle generator into the reaction chamber while the precursor ion is introduced into the reaction chamber; and a voltage applier configured to apply, to the electrode, a voltage for creating an electric field for accelerating product ions generated by a reaction between the precursor ion and the active particle toward the exit of the reaction chamber while the precursor ion and the active particle are introduced into the reaction chamber.

### CROSS-REFERENCE TO RELATED APPLICATION

The present application claims priority to JP App. 2024-095183 filed Jun. 12, 2024. The entire disclosure of the application is hereby incorporated by reference.

### TECHNICAL FIELD

The present invention relates to an ion analyzer configured to generate product ions through a reaction between a precursor ion generated from an analyte and an active particle such as a radical, and to perform a measurement of those product ions.

### BACKGROUND ART

In order to identify and/or quantify analytes in samples, MS/MS analyses using mass spectrometers are generally performed. In an MS/MS analysis, a precursor ion generated from an analyte is introduced into an analysis chamber. The precursor ion is dissociated within the reaction chamber, and the resulting product ions are detected after being separated from each other by their mass.

One of the methods for dissociating a precursor ion is a method in which the precursor ion is made to react with a radical (for example, see JP Pub. 2019-191081). A technique which dissociates a precursor ion by making it react with oxygen radicals is called “oxygen attachment dissociation” (OAD). For example, when a precursor ion originating from a peptide is made to react with oxygen radicals, the peptide can be specifically dissociated at the location where an amino acid is bonded (for example, see WO Pub. 2018/186286). As another example, when a precursor ion generated from an analyte having a hydrocarbon chain is made to react with oxygen radicals, the hydrocarbon chain can be specifically dissociated at the location of an unsaturated bond in the hydrocarbon chain (for example, see WO Pub. 2019/155725).

The reaction chamber contains electrodes for transporting a precursor ion generated from an analyte or product ions generated by the dissociation of the precursor ion to the subsequent stages while converging them along a predetermined ion beam axis. When oxygen radicals are introduced into the reaction chamber and made to react with the precursor ion, unreacted oxygen radicals adhere to the electrodes within the reaction chamber, causing local oxidization of the surface of those electrodes. When a voltage is applied to such electrodes, the oxidized portion will be electrostatically charged (“charge-up”). This causes a disturbance of the electric field created within the reaction chamber, which in turn causes the ions to be dispersed and not converged within the reaction chamber or lowers the transport efficiency of the ions. Consequently, the measurement sensitivity will be lowered.

Although the previous description is concerned with the case of making a precursor ion react with oxygen radicals, a similar problem also occurs in the case of making a precursor ion react with a radical other than oxygen radicals. Furthermore, a similar problem also occurs in the case of dissociating a precursor ion using other kinds of active particles such as ozone or metastable particles.

### SUMMARY OF INVENTION

The problem to be solved by the present invention is to improve the measurement sensitivity for ions in a device in which a precursor ion generated from an analyte is supplied into a reaction chamber along with an active particle and these two kinds of particles are made to react with each other to generate product ions to be analyzed.

An ion analyzer according to the present invention developed for solving the previously described problem includes: a reaction chamber into which a precursor ion generated from an analyte is to be introduced; an electrode located within the reaction chamber; an active particle generator configured to generate an active particle from a predetermined kind of source gas; an active particle introducer configured to introduce an active particle generated by the active particle generator into the reaction chamber while the precursor ion is introduced into the reaction chamber; and a voltage applier configured to apply, to the electrode, a voltage for creating an electric field for accelerating product ions generated by a reaction between the precursor ion and the active particle toward the exit of the reaction chamber while the precursor ion and the active particle are introduced into the reaction chamber.

In the ion analyzer according to the present invention, while a precursor ion generated from an analyte is introduced into the reaction chamber, the active particle introducer introduces an active particle generated by the active particle generator into the reaction chamber to make this particle react with the precursor ion. The precursor ion is thereby dissociated and generates product ions. Meanwhile, the voltage applier applies, to the electrode located within the reaction chamber, a voltage for creating an electric field for accelerating the product ions toward the exit of the reaction chamber while the precursor ion is introduced into the reaction chamber. This causes the product ions to promptly begin their flight within the reaction chamber and thereby prevents the situation in which the ions are dispersed and not converged within the reaction chamber as well as the situation in which the transport efficiency of the ions is lowered. Consequently, the measurement sensitivity will be improved.

### BRIEF DESCRIPTION OF DRAWINGS

FIG. 1 is a diagram showing the configuration of the main components of a mass spectrometer as one embodiment of the ion analyzer according to the present invention.

FIG. 2 is a diagram illustrating the shape of the plate electrodes constituting a multipole ion guide used in the mass spectrometer according to the present embodiment.

FIG. 3 is a diagram illustrating the arrangement of the multipole ion guide within a reaction cell of the mass spectrometer according to the present embodiment.

FIG. 4 is a diagram illustrating the polarity of the radio-frequency voltages applied to the plate electrodes constituting the multipole ion guide in the present embodiment.

FIG. 5 is a diagram illustrating the polarity of the direct voltages applied to the plate electrodes constituting the multipole ion guide in the present embodiment.

FIG. 6 shows the result of an experiment performed with the mass spectrometer according to the present embodiment for confirming the effect of the improvement of the measurement sensitivity for the product ions generated by the collision-induced dissociation of a precursor ion.

FIG. 7 shows the result of another experiment performed with the mass spectrometer according to the present embodiment for confirming the effect of the improvement of the measurement sensitivity for the product ions generated by the collision-induced dissociation of a precursor ion.

FIG. 8 shows the result of a measurement performed for determining the relationship between the acceleration voltage and the measured intensity of the ions in the case of generating product ions by making a positive precursor ion react with oxygen radicals in the mass spectrometer according to the present embodiment.

FIG. 9 shows the result of a measurement performed for determining the relationship between the acceleration voltage and the measured intensity of the ions in the case of generating product ions by making a negative precursor ion react with oxygen radicals in the mass spectrometer according to the present embodiment.

### DESCRIPTION OF EMBODIMENTS

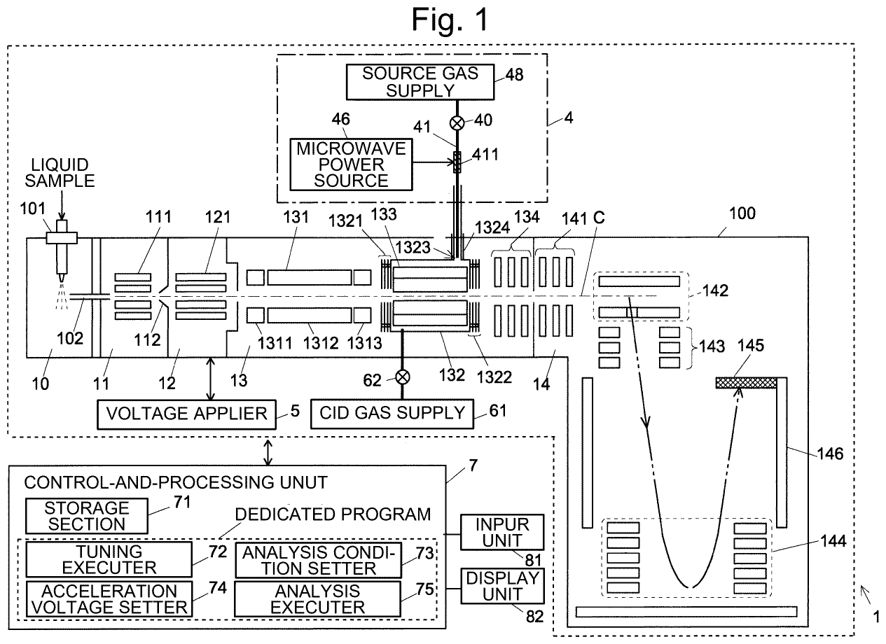

A mass spectrometer 1 as one embodiment of the ion analyzer according to the present invention is hereinafter described with reference to the drawings. It should be noted that the scales (and other geometric features) of the members in the drawings used in the following descriptions are appropriately changed from their actual ratios in order to help understanding of the configuration of the principal members in the present embodiment.

<Configuration of Mass Spectrometer 1> FIG. 1 shows a schematic configuration of the mass spectrometer 1. The mass spectrometer 1 according to the present embodiment is a quadrupole time-of-flight (Q-TOF) mass spectrometer having an atmospheric pressure ion source. This mass spectrometer 1 can be used as a liquid chromatograph mass spectrometer by having a liquid chromatogram (LC) connected to its front end.

The mass spectrometer 1 according to the present embodiment has an ionization chamber 10 and a vacuum chamber 100. The inside of the ionization chamber is at substantially atmospheric pressure. The inner space of the vacuum chamber 100 is divided into a plurality of compartments (in the present embodiment, four compartments), i.e., a first intermediate vacuum chamber 11, second intermediate vacuum chamber 12, first analysis chamber 13 and second analysis chamber 14 sequentially arranged from the ionization chamber 10. These chambers are individually evacuated by vacuum pumps which are not shown (rotary pump and/or turbo molecular pump) to form a multi-stage differential pumping system in which the degree of vacuum sequentially increases from the ionization chamber 10 which is at substantially atmospheric pressure toward the second analysis chamber 14 which is at a high degree of vacuum.

The ionization chamber 10 is provided with an electrospray ionization (ESI) probe 101 configured to spray a liquid sample while imparting electric charges. For example, a liquid sample containing sample components separated from each other by a column in an LC (not shown) is introduced into the ESI probe 101.

The ionization chamber 10 communicates with the first intermediate vacuum chamber 11 through a thin desolvation tube 102 heated by a heat source (not shown). The first intermediate vacuum chamber 11 contains an ion guide 111 consisting of a plurality of rod electrodes arranged around a predetermined ion beam axis C (the central axis of the flight path of ions according to the device design) and configured to converge ions into the vicinity of the ion beam axis C. Each of the electrodes constituting the ion guide 111 and other elements in the mass spectrometer 1 is supplied with an appropriate voltage from a voltage applier 5.

The first and second intermediate vacuum chambers 11 and 12 are separated by a skimmer 112 having a small hole at its apex. The second intermediate vacuum chamber 12 also contains an ion guide 121 consisting of a plurality of rod electrodes arranged around the ion beam axis C and configured to converge ions into the vicinity of the ion beam axis C.

Within the first analysis chamber 13, the following elements are arranged along the ion beam axis C: a quadrupole mass filter 131 configured to separate ions according to their mass-to-charge ratios (m/z); a reaction cell 132 having a multipole ion guide 133 inside; and an ion transport electrode 134 for transporting ions which have passed through the reaction cell 132 to the subsequent stage. Three entrance ring electrodes 1321 are arranged at the entrance end of the reaction cell 132. Similarly, three exit ring electrodes 1322 are arranged at the exit end of the reaction cell 132. Each of the entrance ring electrodes 1321 and the exit ring electrodes 1322 is individually fixed to the reaction cell 132 via an insulator.

In the wall of the reaction cell 132, an opening 1323 for inserting a discharge tube 41 of a radical introducer 4 is provided. This opening 1323 is provided with a cylindrical tube-connecting member 1324 having one end surrounding the opening 1323.

As an example of the radical introducer 4, a device having a similar configuration to the radical introducer disclosed in WO Pub. 2022/059247 can be used. A source-gas supply 48 is connected to the discharge tube 41. Examples of gases available as the source gas include steam for generating oxygen radicals and hydroxyl radicals, oxygen gas for generating oxygen radicals, hydrogen gas for generating hydrogen radicals, nitrogen gas for generating nitrogen radicals, and dry air for generating nitrogen radicals and other active particles. A valve 40 for regulating the flow rate of the source gas is provided in the passage connecting the discharge tube 41 and the source-gas supply 48. A helical antenna 411 is wound around the outer circumferential surface of the discharge tube 41. When microwaves are supplied from a microwave power source 46 to the helical antenna 411 with the source gas being supplied from the source-gas supply 48 into the discharge tube 41, the source gas turns into plasma within the discharge tube 41 and radicals are thereby generated.

A collision-induced dissociation (CID) gas supply 61 is also connected to the reaction cell 132. A valve 62 for regulating the flow rate of the CID gas (e.g., inert gas such as argon gas) to be supplied from the CID gas supply 61 to the reaction cell 132 is provided in the passage connecting the CID gas supply 61 and the reaction cell 132.

Within the reaction cell 132, two kinds of dissociation methods can be carried out, i.e., a dissociation method in which the precursor ion is dissociated through a reaction with radicals, such as oxygen radicals, supplied from the radical introducer 4 (this method is hereinafter called the “radical reaction dissociation”), and a collision-induced dissociation (CID) method in which an amount of energy is imparted to the precursor ion to accelerate and propel this ion into the reaction cell 132 so as to dissociate this ion through the collision with the CID gas.

The quadrupole mass filter 131 has four main rod electrodes 1312. The quadrupole mass filter 131 also has four pre-rod electrodes 1311 in front of the main rod electrodes 1312 (at the end directed to the ionization chamber 10) as well as four post-rod electrodes 1313 at the back of the main rod electrodes 1312 (at the end directed to the second analysis chamber 14).

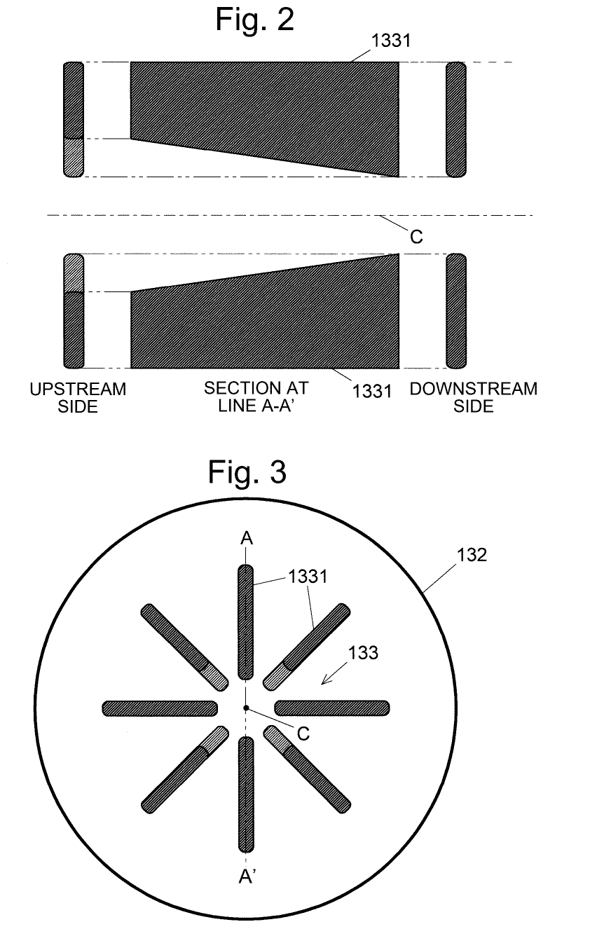

The multipole ion guide 133 consists of eight plate electrodes 1331. As shown in FIG. 2, each plate electrode 1331 has a trapezoidal shape having two sides parallel to each other, one side perpendicular to the two parallel sides, and one side inclined to the two parallel sides. It should be noted that FIG. 2 corresponds to the sectional view at line A-A′ in FIG. 3. FIG. 3 is a diagram showing the inside of the reaction cell 132 observed from the downstream side (i.e., from the exit side of the reaction cell 132). As can be seen in this figure, the eight plate electrodes 1331 are arranged so that the inclined side faces the ion beam axis C, with the direction of the inclination reversed between the neighboring plate electrodes 1331. In the example of FIG. 3, the two vertically positioned plate electrodes 1331 and the two horizontally positioned plate electrodes 1331 are arranged so that the distance of their respective inclined sides to the ion beam axis C decreases from the entrance toward the exit of the reaction cell 132, while the other four plate electrodes 1331 are arranged so that the distance of their respective inclined sides to the ion beam axis C increases from the entrance toward the exit of the reaction cell 132.

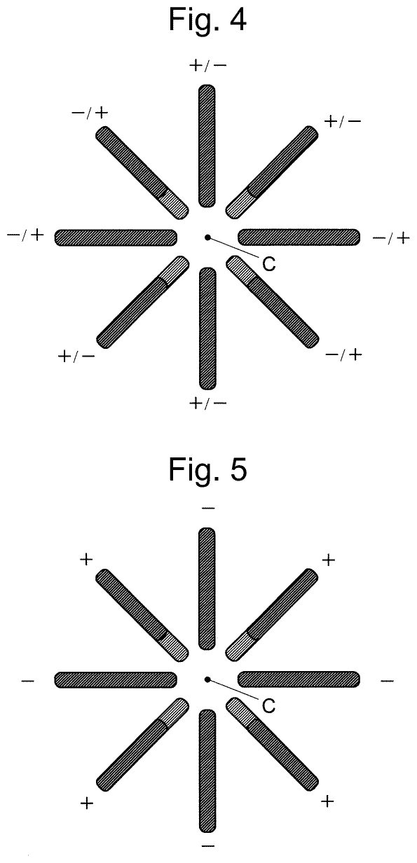

The multipole ion guide 133 is originally intended for creating an electric field which converges ions travelling within the reaction cell 132 into the vicinity of the ion beam axis C. As shown in FIG. 4, radio-frequency voltages are applied from the voltage applier 5 so that two plate electrodes 1331 neighboring each other form one pair, and the polarity of the voltages applied to the plate electrodes 1331 is inverted between the neighboring pairs. This system creates a quadrupole electric field within the reaction cell 132, and ions are converged into the vicinity of the ion beam axis C by this electric field. It should be noted that FIG. 4 (and FIG. 5 which will be described later) also shows the plate electrodes 1331 constituting the multipole ion guide 133 observed from the downstream side of the reaction cell 132.

In the multipole ion guide 133 in the present embodiment, direct voltages for creating an electric field which accelerates ions travelling within the reaction cell 132 (“acceleration voltage”) are also applied from the voltage applier 5 in addition to the previously described radio-frequency voltages.

For example, as described in U.S. Pat. No. 6,163,032, a system consisting of an even number of electrodes arranged around an ion beam axis C in such a manner that their distance from the ion beam axis C gradually changes, with the direction of that change reversed between the neighboring electrodes, creates a potential gradient along the ion beam axis C when direct voltages of opposite polarities are applied to the neighboring electrodes. In the present embodiment, a potential gradient for accelerating an analysis target ion from the entrance side toward the exit side of the reaction cell 132 is created in the multipole ion guide 133 having the configuration described with reference to FIGS. 2 and 3, by applying the direct voltages in such a manner that a direct voltage having the same polarity as the analysis target ion is applied to the four plate electrodes 1331 arranged so that the distance of their inclined sides to the ion beam axis C increases toward the exit of the reaction cell 132, while a direct voltage having the opposite polarity to the analysis target ion is applied to the four plate electrodes 1331 arranged so that the distance of their inclined sides to the ion beam axis C decreases toward the exit of the reaction cell 132, as in FIG. 5 which shows an example of the case where the analysis target ion is a positive ion.

An electric field for accelerating a precursor ion (with collision energy imparted) into the reaction cell 132 is also created in the case of the collision-induced dissociation of the precursor ion. However, the voltages for creating this electric field are applied to the entrance ring electrodes 1321 and/or the exit ring electrodes 1322. In other words, the acceleration voltage described earlier is applied to the plate electrodes 1331 apart from the voltages for imparting collision energy to the precursor ion for collision-induced dissociation. One feature of the mass spectrometer 1 according to the present embodiment exists in that the previously described acceleration voltage is applied in addition to the conventionally used voltages, regardless of whether the radical reaction dissociation or the collision-induced dissociation is performed.

The second analysis chamber 14 includes: an ion transport electrode 141 for transporting ions coming from the first analysis chamber 13; an orthogonal accelerator 142 having a push-out electrode and an extraction electrode arranged to face each other across the ion beam axis C, configured to divert the direction of flight of the ions to a substantially orthogonal direction and send them into the flight space; an acceleration electrode 143 configured to accelerate the ions sent into the flight space by the orthogonal accelerator 142; a reflectron electrode 144 for forming a return path for the ions within the flight space; an ion detector 145; and a flight tube 146 configured to form the flight space inside. The ion detector 145 is an electron multiplier tube or multichannel plate, for example.

The mass spectrometer 1 further includes a control-and-processing unit 7. The control-and-processing unit 7 has a storage section 71. The storage section 71 holds a compound database in which analysis conditions (e.g., measurement conditions and analysis methods) and other related pieces of information for various compounds are recorded.

The storage section 71 also holds the tuning results of the voltages applied to the electrodes in the mass spectrometer 1. This tuning results include, in addition to the results of common tuning processes performed at the time of the shipment or installation of the mass spectrometer 1 (or in other phases), the tuning result of the acceleration voltage applied to the plate electrodes 1331 in order to accelerate ions within the reaction cell 132, acquired for each of the two modes of mass spectrometric analysis, i.e., a mass spectrometric analysis in which product ions are generated from a precursor ion by radical reaction dissociation and a mass spectrometric analysis in which product ions are generated from a precursor ion by collision-induced dissociation. For the radical reaction dissociation, the tuning result of the acceleration voltage is stored for each combination of an analyte compound and a radical species.

The control-and-processing unit 7 includes, as its functional blocks, a tuning executer 72, analysis condition setter 73, acceleration voltage setter 74 and analysis executer 75. For example, the control-and-processing unit 7 may consist of a general-purpose personal computer (PC), with the aforementioned functional blocks embodied by executing, on the processor, dedicated control-and-processing software installed on the same computer. An input unit 81 consisting of a mouse and a keyboard, for example, as well as a display unit 82 consisting of a liquid crystal display, for example, are connected to the control-and-processing unit 7.

<Operation of Mass Spectrometer 1> Next, an operation of the mass spectrometer 1 according to the present embodiment is described. In the present mass spectrometer 1, before an analysis of a real sample is performed, the tuning of the acceleration voltage in the reaction cell 132 is carried out and its result is saved in the storage section 71. The tuning of the acceleration voltage may be performed at the time of the shipment or installation of the device, or before an analysis of a real sample, whichever appropriate. Hereinafter, this tuning operation is initially described. The sample used for the tuning may be a standard sample containing one or more target compounds or a real sample containing analytes.

A user performs a predetermined input operation through the input unit 81 for issuing a command to execute the tuning of the acceleration voltage. Then, the tuning executer 72 shows, on the display unit 82, a screen for allowing the user to enter the name of the target compound for the tuning and the dissociation technique for dissociating that compound (radical reaction dissociation or collision-induced dissociation). The kind of radical to be used should also be entered in the case of the radical reaction dissociation. For the entry of the compound name and the kind of radical, for example, the compounds and radicals recorded in the compound database may be listed on the screen of the display unit 82 to allow the user to select one of the listed items. A plurality of target compounds for the tuning may be entered.

After the name of the target compound for the tuning and the dissociation method have been entered by the user, the tuning executer 72 reads the analysis conditions for the compound concerned from the compound database in the storage section 71 and creates a method file in which the measurement conditions are described. In this step, the method file is created so that the acceleration voltage to be applied to the multipole ion guide 133 within the reaction cell 132 (i.e., the acceleration voltage to be applied to the plate electrodes 1331 arranged so that their distance to the ion beam axis C decreases toward the exit of the reaction cell 132) will be set to a plurality of values at previously determined intervals (e.g., 0.5 V) within a previously determined range (e.g., from 0 V to 5 V) and the measurement will be performed at each of the set values. If a plurality of target compounds have been entered, a method file is created for each of those compounds. After the method files have been created, the tuning executer 72 creates a batch file which sequentially executes those method files.

After the creation of the batch file, the user sets a sample containing the target compounds for the tuning and issues a command to execute the tuning. Then, the analysis executer 75 performs a measurement of each target compound to detect an ion of the target compound under each of the plurality of measurement conditions having different values of the acceleration voltage as described in the corresponding method file. The ion to be selected for the measurement is typically a product ion generated from a precursor ion by radical reaction dissociation or collision-induced dissociation, although the precursor ion may also be selected for the measurement.

In the case of measuring the intensity of the precursor ion, the quadrupole mass filter 131 is operated to non-selectively allow all ions to pass through. Those ions are orthogonally accelerated in the second analysis chamber 14 and made to fly in the return path, and their intensities are ultimately measured with the ion detector 145. In the case of measuring the intensity of the precursor ion, the radical introducer 4 is not energized, nor is the CID gas supplied from the CID gas supply 61. While ions are introduced into the reaction cell 132, the acceleration voltage applied to the multipole ion guide 133 within the reaction cell 132 is set to each of the plurality of values, and the intensity of the ion of the target compound is measured for each value of the acceleration voltage. A mass spectrum is obtained from this measurement. In normal cases, since the mass-to-charge ratio of the precursor ion of the target compound is previously known, the height or area of a mass peak of the ion having that mass-to-charge ratio on the mass spectrum can be used as the measured intensity.

On the other hand, in the case of the measurement of the product ions generated by the radical reaction dissociation of the precursor ion, the radical introducer 4 is energized during the measurement of the target compound to generate radicals from the predetermined kind of source gas according to the measurement conditions so that the generated radicals are introduced into the reaction cell 132 while the precursor ion is introduced into the reaction cell 132. In the case of the collision-induced dissociation of the precursor ion, CID gas is introduced from the CID gas supply 61 into the reaction cell 132 at a predetermined flow rate while the precursor ion is introduced into the reaction cell 132. Whichever dissociation method is used, the acceleration voltage which is set in the previously described manner is applied to the multipole ion guide 133 while the precursor ion of the target compound and the radicals or CID gas are introduced into the reaction cell 132. During this process, the intensity of the product ions of the target compound is measured for each of the plurality of set values of the acceleration voltage. From this measurement, a product ion spectrum of the target compound is obtained for each of the plurality of values of the acceleration voltage. The measured intensity of the product ions may be the total of the measured intensities of all product ions or the measured intensity of one or more product ions having previously determined mass-to-charge ratios.

After the measurements of all target compounds have been completed, the tuning executer 72 prepares, for each target compound, information showing the relationship between the value of the acceleration voltage and the measured intensity of the ions. As can be understood from the foregoing descriptions, both the measured intensity of the precursor ion of the target compound and that of the product ions can be included in the measured intensity of the ions.

The tuning executer 72 subsequently determines the value of the acceleration voltage which yields the highest value of the measured intensity of the ions based on the information showing the relationship between the value of the acceleration voltage and the measured intensity of the ions, relates that value to the name of the target compound, and saves it in the storage section 71. The radical reaction dissociation and the collision-induced dissociation are individually preformed for each compound recorded in the compound database, and the previously described processing is subsequently performed. Thus, the information of the acceleration voltage related to each compound is stored in the storage section 71.

In the situation where the information showing the relationship between the value of the acceleration voltage and the measured intensity of the ions as well as the information of the value of the acceleration voltage which yields the largest value of the measured intensity of the ions have been stored in the storage section 71 for each target compound for the tuning, for each dissociation method and for each radical species, the user performs a predetermined input operation through the input unit 81 to issue a command to execute the analysis. Then, the analysis condition setter 73 initially shows, on the display unit 82, a screen for allowing the user to enter an analyte compound contained in a real sample and the dissociation method for the precursor ion of that analyte compound. Once again, this screen may be configured, for example, to show a list of the compounds recorded in the compound database in the storage section 71 and prompt the user to select one of the listed items as well as to select either the radical reaction dissociation or the collision-induced dissociation. The kind of radical to be used should also be selected in the case of the radical reaction dissociation.

After the user has entered the analyte compound and the dissociation method for the precursor ion as well as the kind of radical (for radical reaction dissociation), the analysis condition setter 73 reads, from the compound database, the analysis condition corresponding to the selected analyte compound and dissociation method for the precursor ion. The acceleration voltage setter 74 reads, from the storage section 71, the tuning result of the acceleration voltage (the value of the acceleration voltage which yields the highest value of the measured intensity of the ions) corresponding to that analysis condition and shows that value on the screen of the display unit 82 along with the graph showing the relationship between the value of the acceleration voltage and the measured intensity of the ions.

Normally, the value of the acceleration voltage which yields the highest value of the measured intensity of the ions should be adopted. However, in some cases, the efficiency of the measurement may be given higher priority than the measured intensity of the ions. For example, this is the case when there are many analyte compounds or when the generation efficiency of the product ions is high. In such a case, for example, the acceleration voltage can be set at a higher value than the value which yields the highest value of the measured intensity of the ions in order to increase the flying speed of the ions within the reaction cell 132. The user checks (and changes as needed) the value of the acceleration voltage shown on the screen of the display unit 82 and performs a predetermined input operation such as the pressing of an “OK” button. Then, the acceleration voltage setter 74 fixes that value of the acceleration voltage as a measurement condition, and the analysis condition setter 73 creates a method file in which the measurement conditions including that value of the acceleration voltage are described.

After the method files describing the measurement conditions have been created for all analyte compounds, the analysis condition setter 73 creates a batch file for continuously executing those method files.

After the batch file has been created, the user sets a sample and issues a command to initiate the measurement. Then, the analysis executer 75 executes the batch file to sequentially perform the measurements for the analyte compounds in the sample. Once again, in the case of the radical reaction dissociation of the precursor ion, the radical introducer 4 is energized during the measurement of the analyte compound to generate radicals from the specified kind of source gas according to the measurement conditions so that the generated radicals are introduced into the reaction cell 132 while the precursor ion is introduced into the reaction cell 132. In the case of the collision-induced dissociation of the precursor ion, CID gas is introduced from the CID gas supply 61 into the reaction cell 132 at a predetermined flow rate while the precursor ion is introduced into the reaction cell 132. Whichever dissociation method is used, the set acceleration voltage is applied from the voltage applier 5 to the multipole ion guide 133 while the precursor ion of the analyte compound and the radicals or CID gas are introduced into the reaction cell 132.

The data produced from the ion detector 145 during the measurement are sequentially saved in the storage section 71. After the completion of the measurement, a product ion spectrum is created based on the data stored in the storage section 71, and the identification and/or quantification of the analyte compound is performed. These processes are similar to conventional analyses, and therefore, detailed descriptions of those processes are omitted.

In a measurement in which radicals are introduced into the reaction cell 132 and made to react with the precursor ion, unreacted radicals adhere to some elements in the reaction cell 132, such as the plate electrodes 1331 constituting the multipole ion guide 133. For example, adhesion of oxygen radicals causes local oxidization of the surface of the plate electrodes 1331. When a voltage is applied to such plate electrodes 1331, the oxidized portion will be electrostatically charged (“charge-up”). This causes a disturbance of the electric field created within the reaction cell 132, which in turn causes the ions to be dispersed and not converged within the reaction cell 132 or lowers the transport efficiency of the ions. Consequently, the measurement sensitivity will be lowered.

The adhesion of an analyte compound or foreign substance to an electrode can also occur in the case of the collision-induced dissociation of a precursor ion. However, this contamination is nothing more than the adhesion of a substance to the electrode surface. In contrast, for example, the adhesion of oxygen radicals additionally causes the oxidization of the electrode surface and thereby induces a charge-up which is more intense than the charge-up resulting from the simple adhesion of a substance to the electrode surface and considerably decreases the measurement sensitivity for ions. The present inventors have conducted various tests of a mass spectrometric analysis in which the collision-induced dissociation of a precursor ion was performed with electrodes whose surface had been oxidized due to the radical reaction dissociation. The test results demonstrated that the measured intensity of the product ions could be decreased to approximately one half of the measured intensity achieved with no oxidization of the electrode surface.

Such a problem is not limited to the oxidization of the electrode surface by oxygen radicals or hydroxyl radicals but can similarly occur due to the reduction of the electrode surface by hydrogen radicals or due to the generation of nitrides on the electrode surface by nitrogen radicals. The same also holds true in the case of dissociating a precursor ion by using ozone, metastable molecules or other particles which are as active as radicals. It should be noted that a “metastable particle” means an atom (metastable atom) or molecule (metastable molecule) which is in an excited state over a long lifetime.

To solve this problem, in the present embodiment, an acceleration voltage for creating an electric field for accelerating ions toward the exit of the reaction cell 132 is applied from the voltage applier 5 to the plate electrodes 1331 constituting the multipole ion guide 133 within the reaction cell 132 when radicals are introduced from the radical introducer 4 into the reaction cell 132 and made to react with the precursor ion, as well as when collision gas is introduced from the CID gas supply 61 into the reaction cell 132 to dissociate the precursor ion. This causes the precursor ion or product ions to promptly begin their flight within the reaction cell 132 and thereby prevents the situation in which the ions are dispersed and not converged within the reaction cell 132 as well as the situation in which the transport efficiency of the ions is lowered. Consequently, the measurement sensitivity will be improved.

### Example

An experiment has been performed to confirm the effect of the application of the acceleration voltage to the plate electrodes 1331 constituting the multipole ion guide 133 in the mass spectrometer 1 according to the present embodiment. The obtained results are hereinafter described.

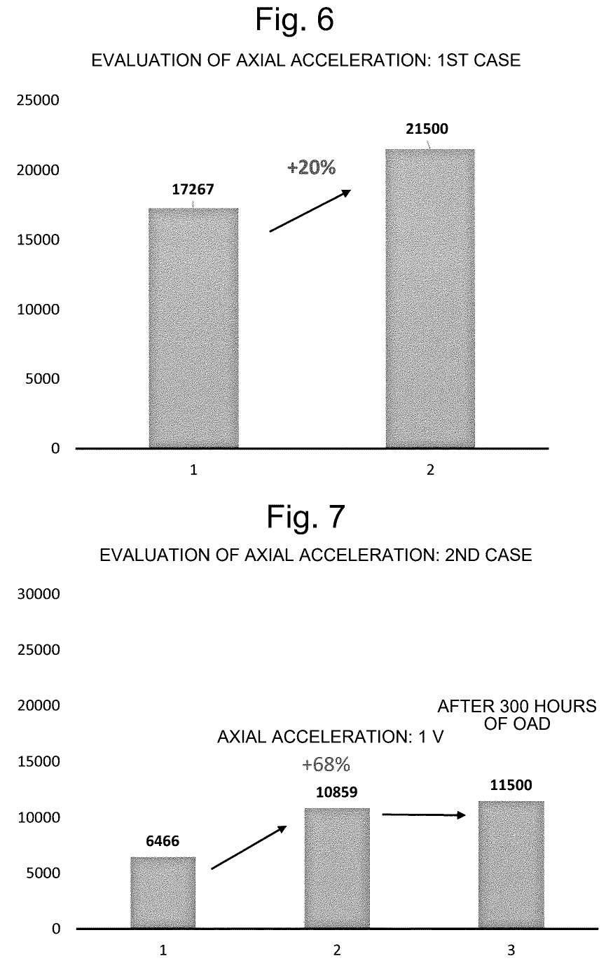

FIG. 6 shows the result of an experiment in which the intensity of a product ion generated by the collision-induced dissociation of a precursor ion originating from reserpine (MRM transition: 609.319>195.06) was measured with an event time of 200 ms. The intensity shown on the left side (17267) is the intensity of the product ion measured without using the acceleration voltage under the condition that the surface of the plate electrodes 1331 was not oxidized. The intensity shown on the right side (21500) is the measured result obtained for the same MRM transition with the acceleration voltage set at 1 V after a mass spectrometric analysis including the radical reaction dissociation of a precursor ion using oxygen radicals had been performed for 100 hours in the mass spectrometer 1, i.e., under the condition that the surface of the plate electrodes 1331 had been oxidized. As can be understood from the comparison of these measured intensities, the measured intensity of the product ion in the present embodiment has increased by 20%. This is quite the opposite to the conventional case in which the measured intensity of the product ion decreased to one half due to the oxidization of the surface of the plate electrodes 1331.

FIG. 7 also shows the result of an experiment in which the intensity of a product ion generated by the collision-induced dissociation of a precursor ion originating from reserpine (MRM transition: 609.319>195.06) was measured with an event time of 200 ms. As with the previous case, the intensity shown on the left side (6466) is the intensity of the product ion measured without using the acceleration voltage under the condition that the surface of the plate electrodes 1331 was not oxidized. It should be noted that the measured intensity shown on the left side in FIG. 7 is different from the measured intensity shown on the left side in FIG. 6 since the device used in the present measurement was different from the device used for obtaining the measurement data shown in FIG. 6. The intensity shown in the middle (10859) is the intensity of the product ion obtained by a measurement with the acceleration voltage set at 1 V under the condition that the surface of the plate electrodes 1331 was not oxidized. The intensity shown on the right side (11500) is the measured result obtained for the same MRM transition with the acceleration voltage set at 1 V after a mass spectrometric analysis including the radical reaction dissociation of a precursor ion using oxygen radicals had been performed for 300 hours in the mass spectrometer 1, i.e., under the condition that the surface of the plate electrodes 1331 had been oxidized. The difference between the intensity shown on the left side and the intensity shown in the middle demonstrates that the measured intensity of the ions has increased by 68% due to the setting of the acceleration voltage. A comparison between the intensity shown in the middle and the intensity shown on the right side shows that, even when the surface of the plate electrode 1331 is oxidized, the measurement sensitivity for ions can be maintained by setting the acceleration voltage.

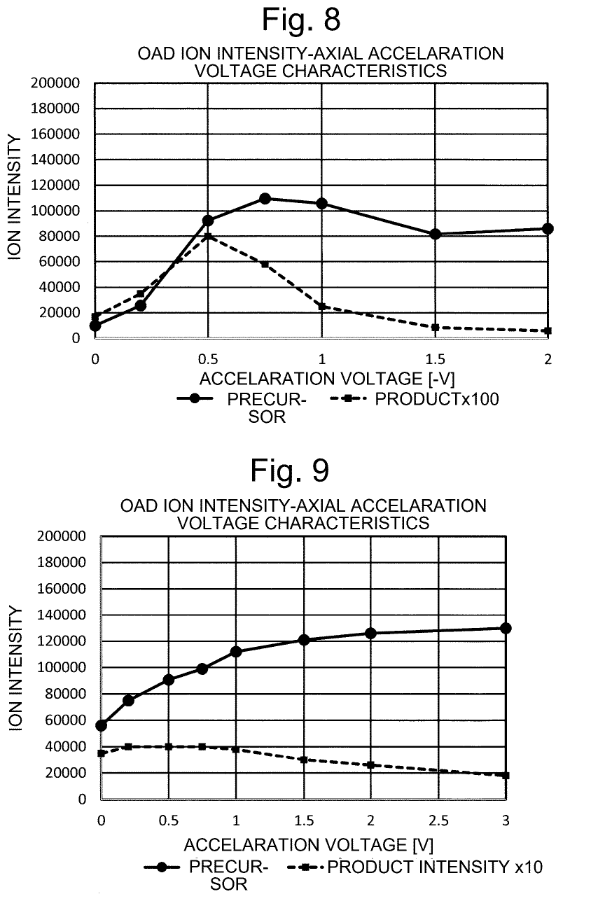

FIG. 8 is the result of a measurement in which the intensity of a product ion generated by the radical reaction dissociation of a positive precursor ion (a protonated ion of the fatty acid LPE18:1) and oxygen radicals (MRM transition: 480.3>384.1) was measured using different values of the acceleration voltage. The amount of LPE18:1 used for the measurement was 400 fmol. An acceleration voltage of 0 V (i.e., no application of the acceleration voltage) corresponds to the conventional technique. A similar measurement was also performed for the aforementioned precursor ion. The graph in FIG. 8 which shows the relationship between the acceleration voltage and the measured intensity of the ion demonstrates that setting the acceleration voltage at 0.5 V increased the measured intensity of the positive product ion to four times the intensity measured under the acceleration voltage of 0 V (i.e., a 300% increase was achieved).

FIG. 9 is the result of a measurement in which the intensity of a product ion generated by the radical reaction dissociation of a negative precursor ion (a deprotonated ion of the fatty acid LPE18:1) and oxygen radicals (MRM transition: 478.3>382.1) was measured using different values of the acceleration voltage. The amount of LPE18:1 used for the measurement was 400 fmol. Once again, an acceleration voltage of 0 V (i.e., no application of the acceleration voltage) corresponds to the conventional technique. A similar measurement was also performed for the aforementioned precursor ion. The graph in FIG. 9 which shows the relationship between the acceleration voltage and the measured intensity of the ions demonstrates that setting the acceleration voltage at 0.5 V increased the measured intensity of the negative product ion by 20% as compared to the intensity measured under the acceleration voltage of 0 V.

The previously described embodiment is a mere example and can be appropriately changed or modified without departing from the spirit of the present invention.

The previously described embodiment was concerned with the case of the radical reaction dissociation in which an analyte was made to react with a radical. The previously described configuration can also be similarly adopted in the case of dissociating a precursor ion by using other active particles such as ozone or metastable particles (active-particle reaction dissociation).

In the previously described embodiment, a different value of the acceleration voltage was determined for each compound, for each dissociation method and for each radical species by the tuning of the acceleration voltage. Although this is a preferable example, a different mode may also be adopted. It is often the case that the same kind of compounds (e.g., peptides) have similar relationships of the value of the acceleration voltage and the measured intensity of the ions. Accordingly, it is possible to tune the acceleration voltage for each kind of compound instead of tuning the acceleration voltage for each individual compound. This enables an efficient acquisition of information representing the relationship between the value of the acceleration voltage and the measured intensity of the ions for each compound. It is also possible to simply set an acceleration voltage for radical reaction dissociation and an acceleration voltage for collision-induced dissociation which are common to all compounds. The acceleration voltage for radical reaction dissociation may have a different value for each radical species or a common value for all radical species.

In the previously described embodiment, the dissociation of the precursor ion was performed within the reaction cell 132 having the form of a linear ion trap. A reaction chamber having a different form may also be used as long as an electric field for accelerating ions can be created within that chamber. Additionally, in the previously described embodiment, the electric field for accelerating ions was created by applying direct voltages to the eight plate electrodes 1331. This shape of electrodes is also a mere example; the electric field for accelerating ions may be created by applying the acceleration voltage is applied to electrodes having other shapes.

The previously described embodiment assumed that the mass spectrometer was capable of both the radical reaction dissociation and collision-induced dissociation. However, a mass spectrometer capable of performing only the radical reaction dissociation is also possible. Furthermore, in the previously described embodiment, a different value of the acceleration voltage was set for each of the radical reaction dissociation and collision-induced dissociation, but this is a mere preferable mode and is not essential. As regards the radical reaction dissociation, the same value of the acceleration voltage may be set regardless of what radical species is used.

The previously described embodiment assumed that the mass spectrometer had a so-called Q-TOF configuration in which a quadrupole mass filter was combined with an orthogonal acceleration time-of-flight mass separator. However, the mass spectrometer may have any type of configuration. Furthermore, the previously described configuration is not limited to mass spectrometers but may also be similarly adopted in other types of ion analyzers such as an ion mobility spectrometer.

[Modes] It is evident to a person skilled in the art that the previously described illustrative embodiment is a specific example of the following modes of the present invention.

(Clause 1) An ion analyzer according to one mode of the present invention includes: a reaction chamber into which a precursor ion generated from an analyte is to be introduced; an electrode located within the reaction chamber; an active particle generator configured to generate an active particle from a predetermined kind of source gas; an active particle introducer configured to introduce an active particle generated by the active particle generator into the reaction chamber while the precursor ion is introduced into the reaction chamber; and a voltage applier configured to apply, to the electrode, a voltage for creating an electric field for accelerating product ions generated by a reaction between the precursor ion and the active particle toward the exit of the reaction chamber while the precursor ion and the active particle are introduced into the reaction chamber.

In the ion analyzer according to Clause 1, while a precursor ion generated from an analyte is introduced into the reaction chamber, the active particle introducer introduces an active particle generated by the active particle generator into the reaction chamber to make this particle react with the precursor ion. The precursor ion is thereby dissociated (active-particle reaction dissociation) and generates product ions. Meanwhile, the voltage applier applies, to the electrode located within the reaction chamber, a voltage for creating an electric field for accelerating product ions toward the exit of the reaction chamber while the precursor ion is introduced into the reaction chamber. This causes the product ions to promptly begin their flight within the reaction chamber and thereby prevents the situation in which the ions are dispersed and not converged within the reaction chamber as well as the situation in which the transport efficiency of the ions is lowered. Consequently, the measurement sensitivity will be improved.

(Clause 2) The ion analyzer according to Clause 2, which is an ion analyzer according to Clause 1, further includes a storage section in which a previously determined value of the voltage to be applied from the voltage applier to the electrode is stored for each combination of the analyte and the kind of active particle, and the voltage applier is configured to read, from the values stored in the storage section, a value corresponding the combination of the analyte and the kind of active particle for which an analysis is to be performed, and to apply the volage having the read value to the electrode. As for the kind of active particle, such classifications as the kind of radical, ozone, and metastable particles can be used, for example.

In the ion analyzer according to Clause 2, an appropriate value of the acceleration voltage for improving the measurement sensitivity for ions can be used for each combination of the analyte and the kind of active particle.

(Clause 3) The ion analyzer according to Clause 3, which is an ion analyzer according to Clause 1 or 2, further includes: a collision-induced dissociation gas introducer configured to introduce a collision-induced dissociation gas into the reaction chamber while the precursor ion is introduced into the reaction chamber; an analysis condition setter configured to receive an input for selecting either active-particle reaction dissociation or collision-induced dissociation; and an analysis executer configured to execute an analysis with an active particle introduced from the active particle introducer into the reaction chamber when an input for selecting active-particle reaction dissociation is received by the analysis condition setter, and to execute an analysis with the collision-induced dissociation gas introduced from the collision-induced dissociation gas introducer into the reaction chamber when an input for selecting collision-induced dissociation is received by the analysis condition setter.

In the ion analyzer according to Clause 3, a mass spectrometric analysis of the product ions generated by dissociating a precursor ion can be performed by two methods, i.e., active-particle reaction dissociation and collision-induced dissociation, using a single device. In normal cases, the location at which the dissociation of the precursor ion occurs changes depending on whether active-particle reaction dissociation or collision-induced dissociation is used. Therefore, information concerning a different partial structure of the analyte can be obtained from product ions generated by each of those dissociation methods.

(Clause 4) In the ion analyzer according to Clause 4, which is an ion analyzer according to Clause 3, the voltage applier is configured to apply, to the electrode, a voltage for creating an electric field for accelerating the product ions toward the exit of the reaction chamber also during a period of time when the precursor ion and the collision-induced dissociation gas are introduced into the reaction chamber.

The ion analyzer according to Clause 4 can improve the measurement sensitivity for ions not only in the case of the active-particle reaction dissociation of a precursor ion of an analyte but also in the case of the collision-induced dissociation of the precursor ion.

(Clause 5) The ion analyzer according to Clause 5, which is an ion analyzer according to one of Clauses 1-4, further includes a tuning executer configured to set a plurality of different values of acceleration voltage, measure the intensity of a product ion generated by active-particle reaction dissociation of a precursor ion of a predetermined target substance using the target substance and a predetermined kind of active particle for each of the plurality of values of acceleration voltage, and determine a value of acceleration voltage which yields the highest value of the measured intensity of the product ion obtained by the measurement.

The ion analyzer according to Clause 5 can automatically determine the optimum value of acceleration voltage even for the combination of an analyte and an active particle for which no value of acceleration voltage has been set beforehand.

1. An ion analyzer, comprising:
a reaction chamber into which a precursor ion generated from an analyte is to be introduced;
an electrode located within the reaction chamber;
an active particle generator configured to generate an active particle from a predetermined kind of source gas;
an active particle introducer configured to introduce an active particle generated by the active particle generator into the reaction chamber while the precursor ion is introduced into the reaction chamber; and
a voltage applier configured to apply, to the electrode, a voltage for creating an electric field for accelerating product ions generated by a reaction between the precursor ion and the active particle toward an exit of the reaction chamber while the precursor ion and the active particle are introduced into the reaction chamber.

2. The ion analyzer according to claim 1, further comprising:
a storage section in which a previously determined value of the voltage to be applied from the voltage applier to the electrode is stored for each combination of the analyte and the kind of active particle,
wherein the voltage applier is configured to read, from the values stored in the storage section, a value corresponding the combination of the analyte and the kind of active particle for which an analysis is to be performed, and to apply the volage having the read value to the electrode.

3. The ion analyzer according to claim 1, further comprising:
a collision-induced dissociation gas introducer configured to introduce a collision-induced dissociation gas into the reaction chamber while the precursor ion is introduced into the reaction chamber;
an analysis condition setter configured to receive an input for selecting either active-particle reaction dissociation or collision-induced dissociation; and
an analysis executer configured to execute an analysis with an active particle introduced from the active particle introducer into the reaction chamber when an input for selecting active-particle reaction dissociation is received by the analysis condition setter, and to execute an analysis with the collision-induced dissociation gas introduced from the collision-induced dissociation gas introducer into the reaction chamber when an input for selecting collision-induced dissociation is received by the analysis condition setter.

4. The ion analyzer according to claim 3, wherein the voltage applier is configured to apply, to the electrode, a voltage for creating an electric field for accelerating the product ions toward the exit of the reaction chamber also during a period of time when the precursor ion and the collision-induced dissociation gas are introduced into the reaction chamber.

5. The ion analyzer according to claim 1, further comprising a tuning executer configured to set a plurality of different values of acceleration voltage, measure the intensity of a product ion generated by active-particle reaction dissociation of a precursor ion of a predetermined target substance using the target substance and a predetermined kind of active particle for each of the plurality of values of acceleration voltage, and determine a value of acceleration voltage which yields the highest value of the measured intensity of the product ion obtained by the measurement.
